(19) United States
(12) Patent Application Publication
(10) Pub. No.: US 2026/0230651 A1
(43) Pub. Date: Aug. 6, 2026

(54) ENCODING METHOD, DECODING METHOD, AND DECODER

(71) Applicant: GUANGDONG OPPO MOBILE TELECOMMUNICATIONS CORP., LTD., Dongguan, Guangdong (CN)

(72) Inventors: Vladyslav ZAKHARCHENKO, San Francisco, CA (US); Yue YU, San Diego, CA (US); Haoping YU, Carmel, IN (US)

(21) Appl. No.: 18/995,991

(22) PCT Filed: Jul. 24, 2023
(86) PCT No.: PCT/US2023/028430

§ 371 Date: Jan. 17, 2025

Related U.S. Application Data
(60) Provisional application No. 63/370,085, filed on Aug. 1, 2022.

(51) Int. Cl. H04N 19/62; H04N 19/18; H04N 19/63; H04N 19/70; H04N 19/93

(52) U.S. Cl. CPC H04N 19/62; H04N 19/18; H04N 19/63; H04N 19/70; H04N 19/93

(57) ABSTRACT

An encoding method, a decoding method, an encoder and a decoder are provided. The encoding method includes the following steps: calculating a plurality of mesh displacements according to a plurality of previously reconstructed meshes; executing a wavelet transform on the plurality of mesh displacements to generate a plurality of wavelet transform coefficients; converting the plurality of wavelet transform coefficients to a plurality of quantized wavelet coefficients based on a plurality of level of details; scanning the plurality of quantized wavelet coefficients along a three-dimensional space to form three one-dimensional arrays for each level of detail; converting the plurality of quantized wavelet coefficients of at least portion of the one-dimensional arrays to generate a plurality of zero-run length codes and level values; and encoding the plurality of zero-run length codes and level values to generate a coded displacement component of a bitstream.

### CROSS-REFERENCE TO RELATED APPLICATION

This application is a U.S. National Stage entry of International Application No. PCT/US2023/028430, filed on Jul. 24, 2023, which claims priority to U.S. provisional Application No. 63/370,085, filed on Aug. 1, 2022. The entire disclosures of the above-mentioned patent applications are hereby incorporated by reference herein and made a part of this specification.

### TECHNICAL FIELD

The present invention relates to the field of image data processing, and specifically, to an encoding method, a decoding method, an encoder and a decoder.

### RELATED ART

In a general image processing from a three-dimensional image to a two-dimensional image, a general image codec may execute two-stage encoding to encode geometry information corresponding to a three-dimensional object in the three-dimensional image. First, the geometry in the three-dimensional image may be decimated to create a base mesh encoded using generic geometry coding methods, i.e., “edgebreaker”. Then the base mesh is hierarchically subdivided, and the difference between the subdivided point and the approximation of the original mesh is stored as a geometry displacements component. The displacement components are packed into the two-dimensional image and encoded with lossless video coding methods.

However, the traditional image process of mapping three-dimensional displacement coefficients to a two-dimensional surface and further video coding may cause coding delay and requires additional memory storage. Therefore, how to encode the three-dimensional displacement coefficients with low storage requirements and efficiently is an important issue in this field.

### SUMMARY OF INVENTION

### Technical Problem

A novel image processing method for efficiently encoding the three-dimensional displacement coefficients and efficiently decoding the three-dimensional displacement coefficients are desirable.

### Solution to Problem

The encoding method of the invention includes the following steps: calculating a plurality of mesh displacements according to a plurality of previously reconstructed meshes; executing a wavelet transform on the plurality of mesh displacements to generate a plurality of wavelet transform coefficients; converting the plurality of wavelet transform coefficients to a plurality of quantized wavelet coefficients based on a plurality of level of details; scanning the plurality of quantized wavelet coefficients along a three-dimensional space to form three one-dimensional arrays for each level of detail; converting the plurality of quantized wavelet coefficients of at least portion of the one-dimensional arrays to generate a plurality of zero-run length codes and level values; binarizing the plurality of zero-run length codes and level values; and encoding the plurality of zero-run length codes and level values to generate a coded displacement component of a bitstream.

The decoding method of the invention includes the following steps: decoding a bitstream to generate a base mesh, and recursively subdividing to a plurality of level of details; decoding a coded displacement component of the bitstream; decoding the bitstream to obtain a plurality of flags and corresponding syntax elements; reconstructing a plurality of values of a plurality of coded displacement wavelet coefficients; processing the plurality of coded displacement wavelet coefficients by an inverse wavelet transform to generate a plurality of mesh displacements; and generating a reconstructed mesh by applying the plurality of mesh displacements to a subdivided base mesh at each level of transform recursively.

The decoder of the invention includes a memory and a processor. The memory is configured to store a plurality of instructions. The processor is electrically connected to the memory, and configured to execute the plurality of instructions to implement the following decoding operations. The processor is configured to decode a bitstream to generate a base mesh, and recursively subdividing to a plurality of level of details, and is configured to decode a coded displacement component of the bitstream. The processor is configured to decode the bitstream to obtain a plurality of flags and corresponding syntax elements, and is configured to reconstruct a plurality of values of a plurality of coded displacement wavelet coefficients. The processor is configured to process the plurality of coded displacement wavelet coefficients by an inverse wavelet transform to generate a plurality of mesh displacements, and is configured to generate a reconstructed mesh by applying the plurality of mesh displacements to a subdivided base mesh at each level of transform recursively.

### BRIEF DESCRIPTION OF DRAWINGS

FIG. 1 is a schematic diagram of an encoder according to an embodiment of the invention.

FIG. 2 is an implementation diagram of an encoder architecture according to an embodiment of the invention.

FIG. 3 is a flow chart of an encoding method according to an embodiment of the invention.

FIG. 4A is a schematic diagram of a base mesh according to an embodiment of the invention.

FIG. 4B is a schematic diagram of determining a plurality of subdivided points of the base mesh of FIG. 4A according to an embodiment of the invention.

FIG. 4C is a schematic diagram of determining a plurality of mesh displacements of the base mesh of FIG. 4B according to an embodiment of the invention.

FIG. 5 is a schematic diagram of a mesh displacement in a three-dimension space according to an embodiment of the invention.

FIG. 6 is a schematic diagram of a plurality of one-dimensional arrays with a plurality of quantized wavelet coefficients according to an embodiment of the invention.

FIG. 7 is a flow chart of coding for a plurality of quantized coefficients according to an embodiment of the invention.

FIG. 8 is a flow chart of coding for a zero-run length according to an embodiment of the invention.

FIG. 9 is a schematic diagram of a decoder according to an embodiment of the invention.

FIG. 10 is a flow chart of a decoding method according to an embodiment of the invention.

### DESCRIPTION OF EMBODIMENTS

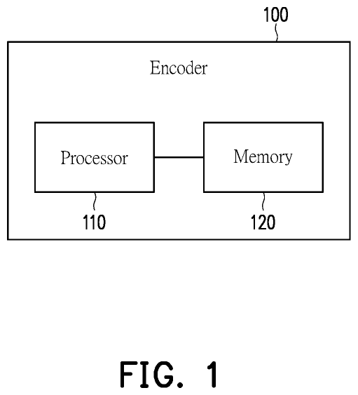

FIG. 1 is a schematic diagram of an encoder according to an embodiment of the invention. Referring to FIG. 1, in the embodiment of the invention, the encoder 100 includes a processor 110 and a memory 120, and the memory 120 may store relevant instructions, and may further store relevant image encoders and relevant image decoders of algorithms. The encoder 100 may be configured to implement a three-dimensional image data encoder disposed in an image processing circuit. The processor 110 is electronically connected to the memory 120, and may execute the relevant image encoders, the relevant image decoders and/or the relevant instructions to implement an encoding method (i.e. three-dimensional image data encoding method) of the invention. In the embodiment of the invention, the encoder 100 may be implemented by one or more personal computer (PC), one or more server computer, and one or more workstation computer or composed of multiple computing devices, but the invention is not limited thereto. In one embodiment of the invention, the encoder 100 may include more processors for executing the relevant image encoders, the relevant image decoders and/or the relevant instructions to implement the encoding method of the invention. The encoder 100 may be used to implement an image codec, and can perform an image data encoding function and an image data decoding function in the invention.

In the embodiment of the invention, the processor 110 may include, for example, a central processing unit (CPU), a graphic processing unit (GPU), or other programmable general-purpose or special-purpose microprocessor, digital signal processor (DSP), application specific integrated circuit (ASIC), programmable logic device (PLD), other similar processing circuits or a combination of these devices. In the embodiment of the invention, the memory 120 may be a non-transitory computer-readable recording medium, such as a read-only memory (ROM), an erasable programmable read-only memory (EPROM), an electrically-erasable programmable read-only memory (EEPROM) or a non-volatile memory (NVM), but the present invention is not limited thereto. In one embodiment of the invention, the relevant image encoders, the relevant image decoders and/or the relevant instructions may also be stored in the non-transitory computer-readable recording medium of one apparatus, and executed by the processor of another one apparatus.

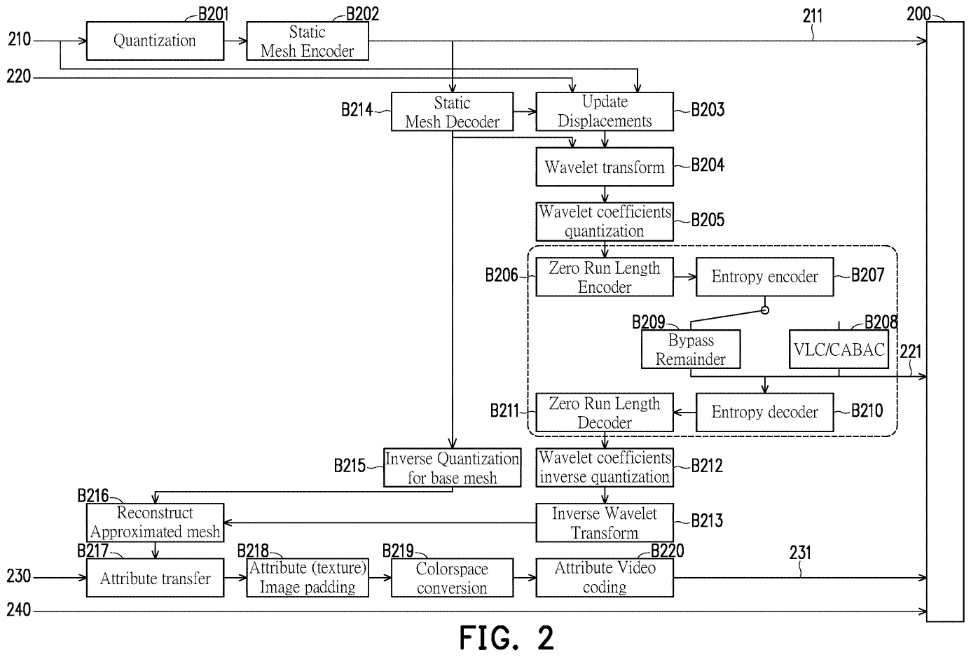

FIG. 2 is an implementation diagram of an encoder architecture according to an embodiment of the invention. Referring to FIG. 1 and FIG. 2, the encoder 100 may encode three-dimensional image data to a coded bitstream with two-dimensional image data by performing the coding process of the encoder architecture of FIG. 2. In the embodiment of the invention, the processor 110 may pre-process, for example, a three-dimensional mesh model corresponding to a three-dimensional object to generate a plurality of base meshes 210, a plurality of mesh displacements 220 (i.e. geometry displacements), a plurality of attribute maps 230 and a patch information component 240. The processor 110 may subdivide the plurality of base meshes 210 to generate the plurality of previously reconstructed meshes. In block B201, the processor 110 may quantize the plurality of previously reconstructed meshes to generate a plurality of quantized base meshes. In block B202, the processor 110 may encode the plurality of quantized base meshes by using a static mesh encoder to generate a coded base mesh component 211 of the bitstream to a multiplexer 200. In block B203, the processor 110 may update the plurality of mesh displacements 220. In block B204, the processor 110 may execute a wavelet transform on the plurality of mesh displacements 220 to generate a plurality of wavelet transform coefficients. In block B205, the processor 110 may quantize the plurality of wavelet transform coefficients to generate to a plurality of quantized wavelet coefficients. In block B206, the processor 110 may convert the plurality of quantized wavelet coefficients to generate a zero-run length code by using a zero-run length encoder. In block B207, the processor 110 may input values of the zero-run length code to an entropy encoder. In block B208, the processor 110 may perform variable length coding (VLC) or context-adaptive binary arithmetic coding (CABAC) on a part of the zero-run length code. In block B208, the processor 110 may also encode another part of the zero-run length code by using a bypass remainder. Thus, the processor 110 may generate a coded displacement component 221 of the bitstream to the multiplexer 200.

In block B210, the processor 110 may input the coded displacement component 221 of the bitstream to an entropy decoder, so as to decode the coded displacement component 221 of a bitstream to generate a corresponding zero-run length code (which may be the same as the original zero-run length code before encoding) by using the entropy decoder. In block B211, the processor 110 may decode the corresponding zero-run length code to generate a plurality of corresponding quantized wavelet coefficients (which may be the same as the original quantized wavelet coefficients before encoding). In block B212, the processor 110 may inversely quantize the corresponding plurality of quantized wavelet transform coefficients to generate a plurality of corresponding wavelet transform coefficients (which may be the same as the original wavelet coefficients before encoding). In block B212, the processor 110 may execute an inverse wavelet transform on the plurality of corresponding wavelet transform coefficients to generate a plurality of corresponding mesh displacements (which may be the same as the mesh displacements before encoding).

In block B214, the processor 110 may decode the coded base mesh component 211 of the bitstream to generate a plurality of corresponding quantized base meshes (which may be the same as the quantized base meshes before encoding) by using a static mesh decoder. In block B215, the processor 110 may inversely quantize the plurality of quantized base meshes to generate a plurality of corresponding base meshes (which may be the same as the base meshes before encoding). In block B216, the processor 110 may reconstruct an approximated mesh according to the plurality of corresponding mesh displacements and the plurality of corresponding base meshes.

In block B217, the processor 110 may execute an attribute transfer on an attribute map according to the approximated mesh to generate a transferred attribute map. In block B218, the processor 110 may perform attribute image padding on the transferred attribute map. In block B219, the processor 110 may perform color space conversion on the transferred attribute map. In block B220, the processor 110 may perform attribute video coding on the transferred attribute map. Thus, the processor 110 may generate a coded attribute map component 231 of the bitstream to the multiplexer 200. Moreover, the processor 110 may provide the patch information component of the bitstream to the multiplexer 200. Therefore, the multiplexer 200 may sequentially output the coded base mesh component 211, the coded displacement component 221, the coded attribute map component 231 and the patch information component 240 of the bitstream.

It should noticed that the above zero-run length coding manner used to encode the mesh displacement in the embodiment may effectively remove the parsing dependency and may be applied immediately after quantizing the wavelet coefficient. Thus, the encoding method and the encoder 100 may effectively reduce or eliminate the coding delay problem in the process of video coding, and reduce the demand for memory storage. The encoding and decoding of mesh displacement will be further explained in detail below.

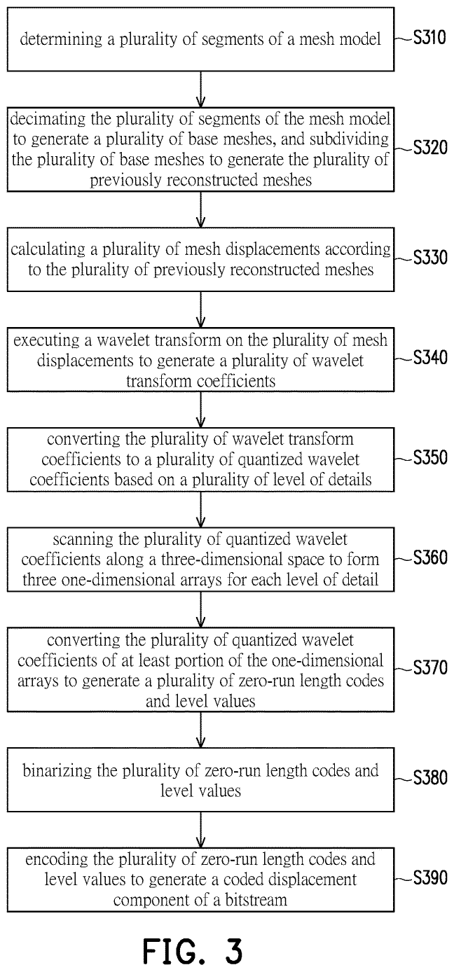

FIG. 3 is a flow chart of an encoding method according to an embodiment of the invention. Referring to FIG. 1 and FIG. 3, the processor 110 may execute the following steps S310 to S390 to implement the encoding of the mesh displacement. In step S310, the processor 110 may determine a plurality of segments of a mesh model. In step S320, the processor 110 may decimate the plurality of segments of the mesh model to generate the plurality of base meshes, and the processor 110 may subdivide the plurality of base meshes to generate the plurality of previously reconstructed meshes. In step S330, the processor 110 may calculate a plurality of mesh displacements according to the plurality of previously reconstructed meshes.

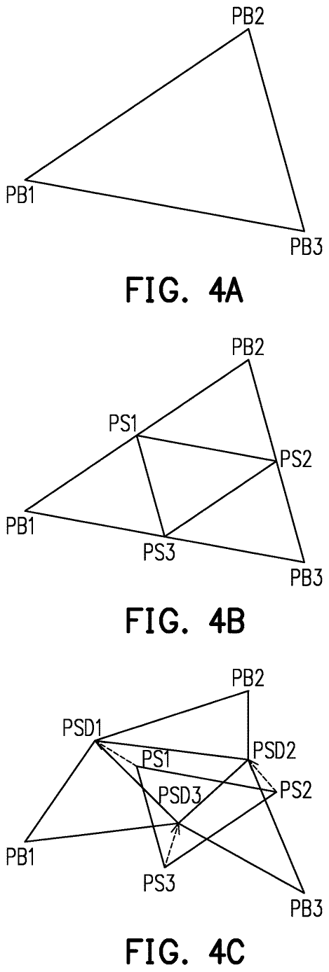

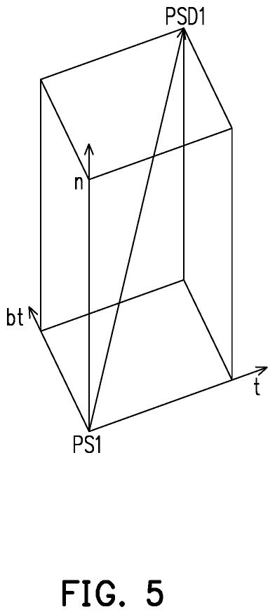

For example, referring to FIG. 4A, the base mesh may consist of the base mesh points PB1, PB2 and PB3. Referring to FIG. 4B, the processor 110 may further determine the subdivided points PS1, PS2 and PS3 according to the base mesh points PB1, PB2 and PB3. The subdivided point PS1 may be calculated as a mid-point between the base mesh points PB1 and PB2. The subdivided point PS2 may be calculated as a mid-point between the base mesh points PB2 and PB3. The subdivided point PS3 may be calculated as a mid-point between the base mesh points PB1 and PB3. Then, the processor 110 may calculate the mesh displacements between a surface of the mesh model and the plurality of previously reconstructed meshes. Referring to FIG. 4C, the processor 110 may determine the subdivided displaced points PSD1, PSD2 and PSD3. Thus, the mesh displacements may be determined by the vectors between the subdivided point PS1 and the subdivided displaced points PSD1, between the subdivided point PS2 and the subdivided displaced points PSD2, and between the subdivided point PS3 and the subdivided displaced points PSD3. Referring to FIG. 5, the mesh displacement between the subdivided point PS1 and the subdivided displaced points PSD1 may be described by a coordinate system of a three-dimensional space as shown in FIG. 5. The three-dimension space may be composed by a bitangent axis (bt), a tangent axis (t) and a normal axis (n).

In step S340, the processor 110 may execute a wavelet transform on the plurality of mesh displacements to generate a plurality of wavelet transform coefficients. In step S350, the processor 110 may convert the plurality of wavelet transform coefficients to a plurality of quantized wavelet coefficients based on a plurality of level of details (LOD). In step S360, the processor 110 may scan the plurality of quantized wavelet coefficients along the three-dimensional space to form three one-dimensional arrays for each level of detail.

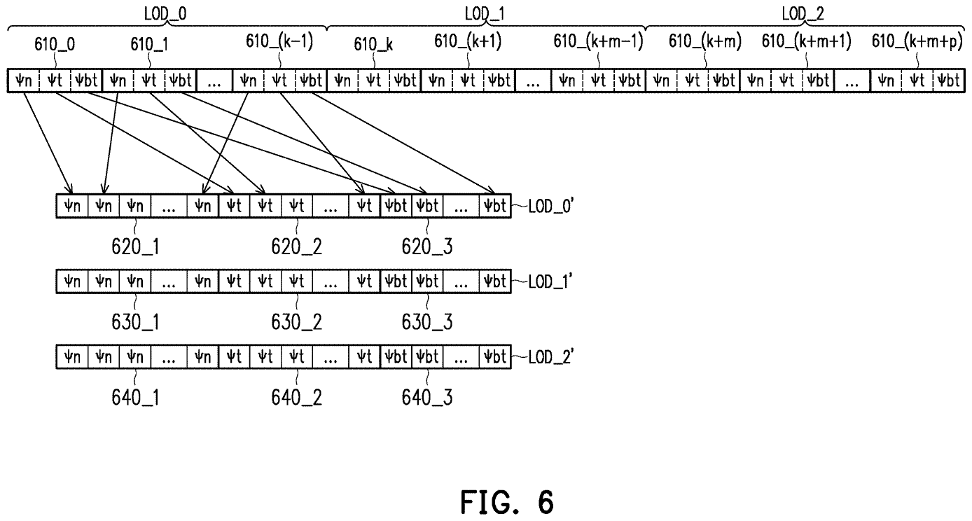

For example, referring to FIG. 6, the processor 110 may convert the plurality of mesh displacements to the plurality of quantized wavelet transform coefficients Ψn, Ψt and Ψbt corresponding to the normal axis (n), the tangent axis (t) and the bitangent axis (bt) and based on three level of details. As shown in FIG. 6, the array LOD_0 may include the quantized wavelet transform coefficient sets 610_0 to 610_(k−1) corresponding to k displacement coefficients, where k is a positive integer. The array LOD_1 may include the quantized wavelet transform coefficient sets 610_k to 610_(k+m−1) corresponding to m displacement coefficients, where m is a positive integer. The array LOD_2 may include the quantized wavelet transform coefficient sets 610_(k+m) to 610_(k+m+p) corresponding to p displacement coefficients, where p is a positive integer. The arrays LOD_0 to LOD_2 may correspond to describe image details corresponding to different image resolutions.

Moreover, the processor 110 may re-arrange the plurality of quantized wavelet coefficients 610_0 to 610_(k+m+p) into same group in the three one-dimensional arrays LOD_0′, LOD_1′ and LOD_2′ respectively according to the normal axis (n), the tangent axis (t) and the bitangent axis (bt). The one-dimensional array LOD_0′ may include three groups 620_1 to 620_3 respectively corresponding to the quantized wavelet transform coefficients of the normal axis (n), the tangent axis (t) and the bitangent axis (bt). The one-dimensional array LOD_1′ may include three groups 630_1 to 630_3 respectively corresponding to the quantized wavelet transform coefficients of the normal axis (n), the tangent axis (t) and the bitangent axis (bt). The one-dimensional array LOD_2′ may include three groups 640_1 to 640_3 respectively corresponding to the quantized wavelet transform coefficients of the normal axis (n), the tangent axis (t) and the bitangent axis (bt).

In step S370, the processor 110 may convert the plurality of quantized wavelet coefficients of at least portion of the one-dimensional arrays to generate a plurality of zero-run length codes and level values (corresponding to a certain level of detail). In the embodiment of the invention, the processor 110 may determine to encode part of the one-dimensional arrays according to the requirement of the image resolution. In step S380, the processor 110 may binarize the plurality of zero-run length codes and level values. In step S390, the processor 110 may encode the plurality of zero-run length codes and level values to generate a coded displacement component of a bitstream. Encoding the coded displacement component (i.e. an array of displacements), the processor 110 may use a pair of zero-run length code followed by the corresponding value code (or level of the non-zero coefficient).

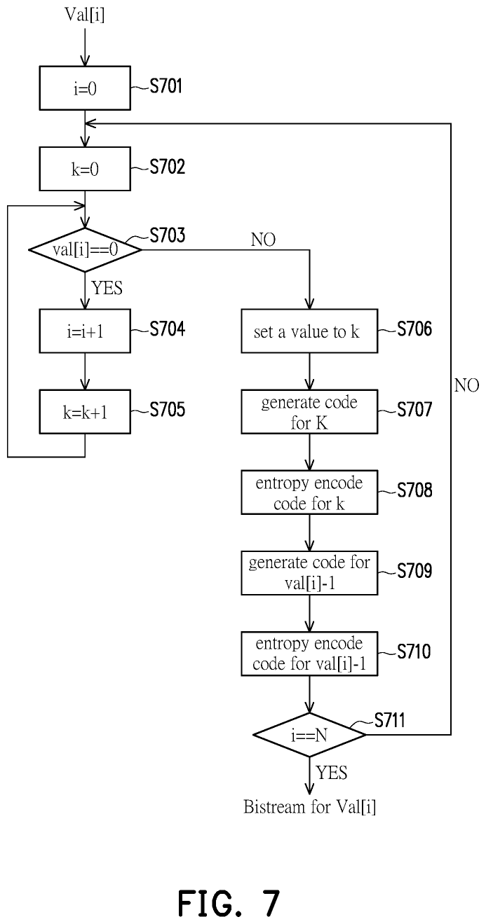

Referring to FIG. 7, in one embodiment of the invention, the processor 110 may execute the steps S701 to S711 to implement zero-run length coding and generate the coded displacement component of the bitstream. The processor 110 may encode an array of values val[i], and the size of the array of values val[i] may be N elements, where N is positive integer. In the embodiment of the invention, the each value of the zero-run length code may be implemented as a combination of a plurality of context-coded flags, a bypass-coded binarized reminder and a parity flag. For example, as the following formula (1), each value val[i] may be implemented as a combination of the context-coded flags gt_0 to gt_K and gtN_1 to gtN_L, the bypass-coded binarized reminder R and the parity flag P, where K and L are positive integers. In the formula (1), the gt_0 to gt_K flags represent if the value is greater than the corresponding values of 0 to K, and the gtN_1 to gtN_L flags represent if the value is greater than the values N_1 to N_L. The plurality of context-coded flags gt_0 to gt_K and gtN_1 to gtN_L and the parity flag P are binary. Formula (1) is a binarization process, and the goal of the binarization process is to convert quantized value with a fixed bit representation (e.g. 16 bit) to a variable length code base on generalized statistics of value distribution. Moreover, the bypass-coded binarized reminder R may be calculated by the following formula (2). In the embodiment of the invention, the processor 110 may encode the plurality of context-coded flags gt_0 to gt_K and gtN_1 to gtN_L by using an arithmetic encoder with a context model, and encode the bypass-coded binarized reminder R by using an exponential Golomb encoder.

$$val [ i ] = gt\_ 0 + gt\_ 1 + … + gt\_i + … + gt\_K + P + ( gtN\_ 0 + gtN\_ 2 + … + gtN\_j + … + gtN\_L + R ) \times 2 \qquad ( 1 )$$

$$R = ( val [ i ] - {\sum }_{i = 0}^{K} gt\_i - P - ( 2 \times {\sum }_{i}^{L} gtN\_j ) ) / 2 \qquad ( 2 )$$

In step S701, the processor 110 sets the parameter i equal to 0. In step S702, the processor 110 sets the parameter k equal to 0. In step S703, the processor 110 determines whether the value val[i] is equal to 0. If yes, in step S704, the processor 110 sets the parameter i equal to i+1. In step S705, the processor 110 sets the parameter k equal to k+1, and the processor 110 execute step 703 in a loop. If no, in step S706, the processor 110 sets a corresponding value of the zero-run length to the parameter k. In step S707, the processor 110 generates a corresponding code for the parameter K. In step S708, the processor 110 entropy encodes a corresponding code for the parameter k. In step S709, the processor 110 generates code for value val[i]−1. In step S710, the processor 110 determines whether the parameter i is equal to N. If no, the processor 110 executes step S702 in a loop. If yes, the processor 110 completes encoding and outputs the coded displacement component of the bitstream. More specifically, in step S707 and S709, the processor 110 may execute the binarization process to generate optimal length bi-bodes to represent K based on statistical characteristics of values distribution for K, and the processor 110 may use a truncated Golomb Rice code to generate the corresponding code for the parameter K. That is, the processor 110 may convert the zero run length code into binary representation by using the truncated Golomb Rice code. Then, after binarizing the values, the processor 110 may use some method for entropy encoding.

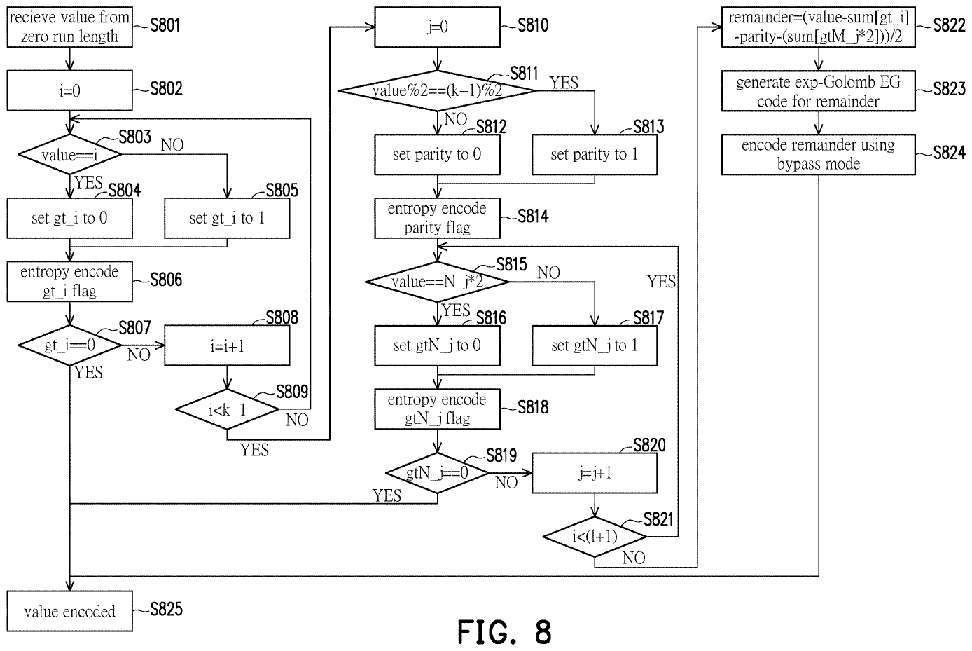

Referring to FIG. 8, in one embodiment of the invention, the processor 110 may execute the following steps S801 to S825 to implement the coding of steps S708 and S710, but the invention is not limited thereto. In step S801, the processor 110 receives the value from, for example, the zero-run length or the non-zero value, but the invention is not limited thereto. In step S802, the processor 110 sets the parameter t to equal 0. In step S803, the processor 110 determines whether the value is equal to i. If yes, in step S804, the processor 110 sets the flag gt_i to 0. If no, in step S805, the processor 110 sets the flag gt_i to 1. In step S806, the processor 110 entropy encodes the flag gt_i. In step S807, the processor 110 determines whether the value of the flag gt_i. is equal to 0. If yes, in step S825, the processor 110 completes the encoding of the value. If no, in step S808, the processor 110 sets the parameter i equal to i+1. In step S809, the processor 110 determines whether the parameter i is less than k+1. If no, the processor 110 executes step S803 in a loop. If yes, in step S810, the processor 110 sets the parameter j equal to 0. In step S811, the processor 110 determines whether the remainder of the value divided by 2 is equal to the remainder of (k+1) divided by 2. If no, the value is even, and the processor 110 sets the value of the parity R to 0. If yes, the value is odd, and the processor 110 sets the value of the parity flag R to 0. In step S814, the processor 110 entropy encodes the parity flag R.

In step S815, the processor 110 determines whether the value is equal to double N_j. If yes, in step S816, the processor 110 sets the value of the flag gtN_j to 0. If no, in step S817, the processor 110 sets the value of the flag gtN_j to 1. In step S818, the processor 110 entropy encodes the flag gtN_j. In step S819, the processor 110 determines that the value of the flag gtN_j equal to 0. If yes, in step S825, the processor 110 completes the encoding of the value. If no, in step S819, the processor 110 sets the parameter j equal to j+1. In step S821, the processor 110 determines whether the parameter i less than the (1+1). If yes, the processor 110 executes step S815 in a loop. If no, in step S822, the processor 110 calculates the reminder according to the above formula (2). In step S823, the processor 110 generates an exponential Golomb EG code for the reminder. In step S824, the processor 110 encodes the remainder using bypass mode. In step S825, the processor 110 completes the encoding of the value.

In the embodiment of the invention, the generalization of the k-th order Exp-Golomb binarization process is described below (the preset invention may use the 2nd order Exp-Golomb binarization process). In the case of non-zero code, the sign bit encoded to 1 indicates a positive number, and encoded to 0 indicates a negative number as the following formula (3), where the parameter CO is a non-zero wavelet coefficient, and the parameter Sign is a binary.

$$CO = ( 2 \times Sign - 1 ) \times ( gt\_ 0 + gt\_ 1 + … + gt\_K + P + ( gtN\_ 0 + gtN\_ 2 + … + gtN\_L + R ) \times 2 + 1 ) \qquad ( 3 )$$

The bin string of the k-th order Exp-Golomb binarization process for each value symbolVal c(i) is specified as follows, where each call of the function put (X), with X being equal to 0 or 1, adds the binary value X at the end of the bin string. The processor 110 may execute the following program codes in the following table 1 to implement the k-th order Exp-Golomb binarization process.

TABLE 1

```
absV = Abs( symbolVal )
stopLoop = 0
do
  if( absV >= ( 1 << k ) ) {
    put( 1 )
    absV = absV − ( 1 << k )
    k++
  } else {
    put( 0 )
    while( k−− )
      put( ( absV >> k ) & 1 )
    stopLoop = 1
  }
while( !stopLoop )
```

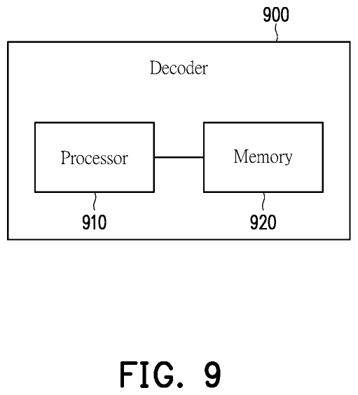

FIG. 9 is a schematic diagram of a decoder according to an embodiment of the invention. Referring to FIG. 9, in the embodiment of the invention, the decoder 900 includes a processor 910 and a memory 920, and the memory 920 may store relevant instructions, and may further store relevant image encoders and relevant image decoders of algorithms. The decoder 900 may be configured to implement a three-dimensional image data decoder disposed in an image processing circuit. The processor 910 is electronically connected to the memory 920, and may execute the relevant image encoders, the relevant image decoders and/or the relevant instructions to implement a decoding method (i.e. three-dimensional image data decoding method) of the invention. In the embodiment of the invention, the decoder 900 may be implemented by one or more personal computer (PC), one or more server computer, and one or more workstation computer or composed of multiple computing devices, but the invention is not limited thereto. In one embodiment of the invention, the decoder 900 may include more processors for executing the relevant image encoders, the relevant image decoders and/or the relevant instructions to implement the encoding method of the invention. The decoder 900 may be used to implement an image codec, and can perform an image data encoding function and an image data decoding function in the invention.

In the embodiment of the invention, the decoder 900 may be implement as a receiver end (RX) for decoding and displaying the three-dimensional image (e.g. a display device or a terminal device), and the encoder 100 of FIG. 1 may be implement as a transmitter end (TX) for encoding and outputting the encoded bitstream (e.g. an image data source). The encoder 100 of FIG. 1 may encode three-dimensional image data to the coded bitstream, and the decoder 900 may receive the coded bitstream from the encoder 100 of FIG. 1. The decoder 900 may decode the coded bitstream to a base mesh and corresponding mesh displacements, so as to generate the three-dimensional image.

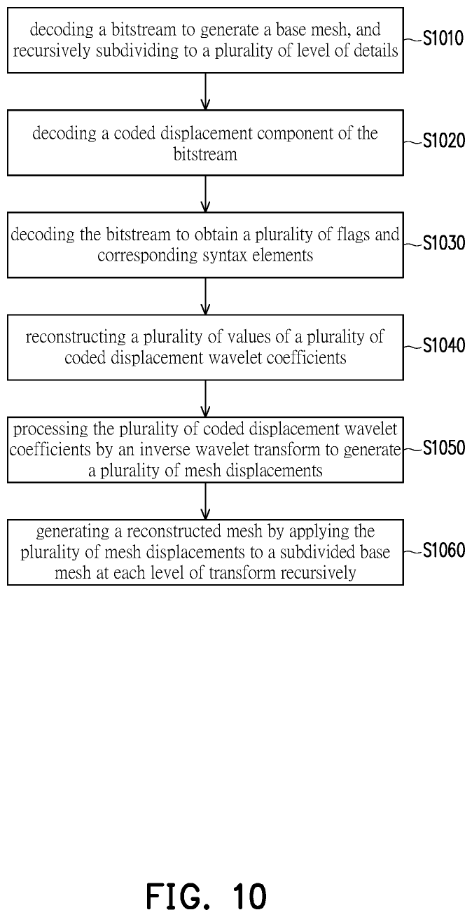

FIG. 10 is a flow chart of a decoding method according to an embodiment of the invention. Referring to FIG. 9 and FIG. 10, the processor 910 of the decoder 900 may receive the bitstream provided from the encoder 100 of FIG. 1 or the multiplexer 200 of FIG. 2 may execute the following steps S1010 to S1060 to implement the decoding of the mesh displacement. In step S1010, the processor 910 may decode the bitstream to generate a base mesh, and recursively subdividing to the level of details. In the embodiment of the invention, the level of details is defined by a corresponding encoder (e.g. the encoder 100 of FIG. 1) providing the bitstream. In step S1020, the processor 910 may obtain a coded displacement component of the bitstream, and decode the coded displacement component of the bitstream. In the embodiment of the invention, the processor 910 may decode the coded displacement component of the bitstream by using the bypass decoder. In one embodiment of the invention, the processor 910 may decode the coded displacement component of the bitstream by the context adaptive decoder. In step S1030, the processor 910 may decode the bitstream to obtain the flags and corresponding syntax elements. In the embodiment of the invention, the processor 910 may decode the bitstream by using context coding for flags and de-binarization of the bypass coded remainder to obtain the flags and corresponding syntax elements. In step S1040, the processor 910 may reconstruct the value of the coded displacement wavelet coefficients. In the embodiment of the invention, the value of the coded displacement wavelet coefficient may be reconstructed by using the following formula (4), and for zero-run length wavelet coefficients code may be reconstructed by using the following formula (5).

$$value = ( {\sum }_{i = 0}^{K} gt\_ 1 + P + ( R + {\sum }_{j = 0}^{L} gtN\_j ) \times 2 ) \times ( 2 \times sign - 1 ) \qquad ( 4 )$$

$$value = {\sum }_{i = 0}^{K} gt\_i + P + ( R + {\sum }_{j = 0}^{L} gtN\_j ) \times 2 \qquad ( 5 )$$

In step S1050, the processor 910 may process the coded displacement wavelet coefficients by an inverse wavelet transform to generate the mesh displacements. In step S1060, the processor 910 may generate a reconstructed mesh by applying the mesh displacements to the subdivided base mesh at each level of transform recursively. Therefore, the processor 910 at the receiving end may effectively decode the bitstream to obtain the base mesh and the corresponding mesh displacements.

In summary, the encoding method, the decoding method, the encoder and the decoder of the invention can implement high-efficiency image encoding and image decoding operations of the displacement components by using the zero-run length coding method, and can effectively reduce the demand for storage space.

The encoding method of the invention includes the following steps: calculating a plurality of mesh displacements according to a plurality of previously reconstructed meshes; executing a wavelet transform on the plurality of mesh displacements to generate a plurality of wavelet transform coefficients; converting the plurality of wavelet transform coefficients to a plurality of quantized wavelet coefficients based on a plurality of level of details; scanning the plurality of quantized wavelet coefficients along a three-dimensional space to form three one-dimensional arrays for each level of detail; converting the plurality of quantized wavelet coefficients of at least portion of the one-dimensional arrays to generate a plurality of zero-run length codes and level values; binarizing the plurality of zero-run length codes and level values; and encoding the plurality of zero-run length codes and level values to generate a coded displacement component of a bitstream.

In an embodiment of the invention, the encoding method further includes the following steps: determining a plurality of segments of a mesh model; and decimating the plurality of segments of the mesh model to generate the plurality of previously reconstructed meshes.

In an embodiment of the invention, the step of calculating the plurality of mesh displacements includes: calculating the plurality of mesh displacements between a surface of the mesh model and the plurality of previously reconstructed meshes.

In an embodiment of the invention, the three-dimension space is composed by a bitangent axis, a tangent axis, and a normal axis. The three one-dimensional arrays include the plurality of quantized wavelet coefficients of the mesh displacements corresponding to the bitangent axis, the tangent axis and the normal axis.

In an embodiment of the invention, the step of forming the three one-dimensional arrays for the each level of detail includes: arranging the plurality of quantized wavelet coefficients into same group in the one-dimensional array respectively according to the bitangent axis, the tangent axis and the normal axis.

In an embodiment of the invention, the step of encoding the plurality of zero-run length codes and the level values includes: converting the zero run length code into binary representation by using truncated Golomb Rice code, and encoding the plurality of zero-run length codes and the level values by using an entropy encoder.

In an embodiment of the invention, each value of the plurality of zero-run length codes is implemented as a combination of a plurality of context-coded flags, a bypass-coded binarized reminder and a parity flag.

In an embodiment of the invention, the plurality of context-coded flags and the parity flag are binary.

In an embodiment of the invention, the step of encoding the plurality of zero-run length codes and the level values includes: encoding the plurality of context-coded flags by using an arithmetic encoder with a context model.

In an embodiment of the invention, the step of encoding the plurality of zero-run length codes and the level values includes: encoding the bypass-coded binarized reminder by using an exponential Golomb encoder.

In an embodiment of the invention, the encoding method further includes the following steps: quantizing the plurality of previously reconstructed meshes to generate a plurality of quantized base meshes; and encoding the plurality of quantized base meshes to generate a coded base mesh component of the bitstream by using a static mesh encoder.

In an embodiment of the invention, the encoding method further includes the following steps: decoding the coded displacement component of a bitstream to generate another zero-run length code by using an entropy decoder; decoding the another zero-run length code by using a zero-run length decoder to generate another plurality of wavelet transform coefficients; executing an inverse wavelet transform on the another plurality of wavelet transform coefficients to generate another plurality of mesh displacements; decoding the coded base mesh component of the bitstream by using a static mesh decoder to generate another plurality of quantized base meshes; inversely quantizing the another plurality of quantized base meshes to generate another plurality of base meshes; and reconstructing an approximated mesh according to the another plurality of mesh displacements and the another plurality of base meshes.

In an embodiment of the invention, the encoding method further includes the following steps: executing an attribute transfer on an attribute map according to the approximated mesh to generate a transferred attribute map; and performing attribute image padding, color space conversion and attribute video coding on the transferred attribute map to generate a coded attribute map component of the bitstream.

In an embodiment of the invention, the encoding method further includes the following step: providing a patch information component of the bitstream.

The decoding method of the invention includes the following steps: decoding a bitstream to generate a base mesh, and recursively subdividing to a plurality of level of details; decoding a coded displacement component of the bitstream; decoding the bitstream to obtain a plurality of flags and corresponding syntax elements; reconstructing a plurality of values of a plurality of coded displacement wavelet coefficients; processing the plurality of coded displacement wavelet coefficients by an inverse wavelet transform to generate a plurality of mesh displacements; and generating a reconstructed mesh by applying the plurality of mesh displacements to a subdivided base mesh at each level of transform recursively.

In an embodiment of the invention, the step of decoding the coded displacement component of the bitstream includes: decoding the coded displacement component of the bitstream by using a bypass decoder.

In an embodiment of the invention, the step of decoding the coded displacement component of the bitstream includes: decoding the coded displacement component of the bitstream by using a context adaptive decoder.

In an embodiment of the invention, the step of decoding the bitstream to obtain the plurality of flags and corresponding syntax elements includes: decoding the bitstream using context coding for flags and de-binarization of the bypass coded remainder to obtain the plurality of flags and corresponding syntax elements.

In an embodiment of the invention, the level of details is defined by a corresponding encoder providing the bitstream.

The encoder of the invention includes a memory and a processor. The processor is configured to calculate a plurality of mesh displacements according to a plurality of previously reconstructed meshes, and is configured to execute a wavelet transform on the plurality of mesh displacements to generate a plurality of wavelet transform coefficients. The processor is configured to convert the plurality of wavelet transform coefficients to a plurality of quantized wavelet coefficients based on a plurality of level of details, and is configured to scan the plurality of quantized wavelet coefficients along a three-dimensional space to form three one-dimensional arrays for each level of detail. The processor is configured to convert the plurality of quantized wavelet coefficients of at least portion of the one-dimensional arrays to generate a plurality of zero-run length codes and level values, and is configured to binarize the plurality of zero-run length codes and level values. The processor is configured to encode the plurality of zero-run length codes and level values to generate a coded displacement component of a bitstream.

In an embodiment of the invention, the processor is configured to determine a plurality of segments of a mesh model, and is configured to decimate the plurality of segments of the mesh model to generate the plurality of base meshes. The processor is configured to subdivide the plurality of base meshes to generate the plurality of previously reconstructed meshes.

In an embodiment of the invention, the processor is configured to calculate the plurality of mesh displacements between a surface of the mesh model and the plurality of previously reconstructed meshes.

In an embodiment of the invention, the three-dimension space is composed by a bitangent axis, a tangent axis and a normal axis, and the three one-dimensional arrays comprises the plurality of quantized wavelet coefficients of the mesh displacements corresponding to the bitangent axis, the tangent axis, and the normal axis.

In an embodiment of the invention, the processor is configured to arrange the plurality of quantized wavelet coefficients into same group in the one-dimensional array respectively according to the bitangent axis, the tangent axis, and the normal axis.

In an embodiment of the invention, the processor is configured to convert the zero run length code into binary representation by using truncated Golomb Rice code, and is configured to encode the plurality of zero-run length codes and the level values by using an entropy encoder.

In an embodiment of the invention, each value of the plurality of zero-run length codes is implemented as a combination of a plurality of context-coded flags, a bypass-coded binarized reminder and a parity flag.

In an embodiment of the invention, the plurality of context-coded flags and the parity flag are binary.

In an embodiment of the invention, the processor is configured to encode the plurality of context-coded flags by using an arithmetic encoder with a context model.

In an embodiment of the invention, the processor is configured to encode the bypass-coded binarized reminder by using an exponential Golomb encoder.

In an embodiment of the invention, the processor is configured to quantize the plurality of previously reconstructed meshes to generate a plurality of quantized base meshes, and is configured to encode the plurality of quantized base meshes to generate a coded base mesh component of the bitstream by using a static mesh encoder.

In an embodiment of the invention, the processor is configured to decode the coded displacement component of a bitstream to generate another zero-run length code by using an entropy decoder, and is configured to decode the another zero-run length code to generate another plurality of quantized wavelet transform coefficients by using a zero-run length decoder. The processor is configured to inversely quantize the another plurality of quantized wavelet transform coefficients to generate another plurality of wavelet transform coefficients, and is configured to execute an inverse wavelet transform on the another plurality of wavelet transform coefficients to generate another plurality of mesh displacements. The processor is configured to decode the coded base mesh component of the bitstream to generate another plurality of quantized base meshes by using a static mesh decoder, and is configured to inversely quantize the another plurality of quantized base meshes to generate another plurality of base meshes. The processor is configured to reconstruct an approximated mesh according to the another plurality of mesh displacements and the another plurality of base meshes.

In an embodiment of the invention, the processor is configured to execute an attribute transfer on an attribute map according to the approximated mesh to generate a transferred attribute map, and is configured to perform attribute image padding, color space conversion and attribute video coding on the transferred attribute map to generate a coded attribute map component of the bitstream.

In an embodiment of the invention, the processor is configured to provide a patch information component of the bitstream.

The decoder of the invention includes a memory and a processor. The memory is configured to store a plurality of instructions. The processor is electrically connected to the memory, and configured to execute the plurality of instructions to implement the following decoding operations. The processor is configured to decode a bitstream to generate a base mesh, and recursively subdividing to a plurality of level of details, and is configured to decode a coded displacement component of the bitstream. The processor is configured to decode the bitstream to obtain a plurality of flags and corresponding syntax elements, and is configured to reconstruct a plurality of values of a plurality of coded displacement wavelet coefficients. The processor is configured to process the plurality of coded displacement wavelet coefficients by an inverse wavelet transform to generate a plurality of mesh displacements, and is configured to generate a reconstructed mesh by applying the plurality of mesh displacements to a subdivided base mesh at each level of transform recursively.

In an embodiment of the invention, the processor is configured to decode the coded displacement component of the bitstream by using a bypass decoder.

In an embodiment of the invention, the processor is configured to decode the coded displacement component of the bitstream by using a context adaptive decoder.

In an embodiment of the invention, the processor is configured to decode the bitstream using context coding for flags and de-binarization of the bypass coded remainder to obtain the plurality of flags and corresponding syntax elements.

In an embodiment of the invention, the level of details is defined by a corresponding encoder providing the bitstream.

Based on the above, according to the encoding method, the decoding method, the encoder and the decoder of the invention can perform high-efficiency encoding operation and decoding operation of the displacement components.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

### REFERENCE SIGNS LIST

100: Encoder
110, 910: Processor
120, 920: Memory
200: Multiplexer
211: Coded base mesh component
221: Coded displacement component
231: Coded attribute map component
210: Base meshes
220: Besh displacements
230: Attribute maps
240: Patch information component
900: Decoder
B201~B220: Block
S310~S390, S701~S711, S801~S825, S1010~S1060: Step
PB1, PB2, PB3: Base mesh point
PS1, PS2, PS3: Subdivided point
PSD1, PSD2, PSD3: Subdivided displaced point
n: Normal axis
bt: Bitangent axis
t: Tangent axis
LOD_1, LOD_2, LOD_3, LOD_1′, LOD_2′, LOD_3′: Array
610_0~610_(k+m+p): Quantized wavelet coefficient
Ψn, Ψt, Ψbt: Quantized wavelet transform coefficient

1. An encoding method, comprising:
calculating a plurality of mesh displacements according to a plurality of previously reconstructed meshes;
executing a wavelet transform on the plurality of mesh displacements to generate a plurality of wavelet transform coefficients;
converting the plurality of wavelet transform coefficients to a plurality of quantized wavelet coefficients based on a plurality of level of details;
scanning the plurality of quantized wavelet coefficients along a three-dimensional space to form three one-dimensional arrays for each level of detail;
converting the plurality of quantized wavelet coefficients of at least portion of the one-dimensional arrays to generate a plurality of zero-run length codes and level values;
binarizing the plurality of zero-run length codes and level values; and
encoding the plurality of zero-run length codes and level values to generate a coded displacement component of a bitstream.

2. The encoding method according to claim 1, further comprising:
determining a plurality of segments of a mesh model; and
decimating the plurality of segments of the mesh model to generate the plurality of base meshes, and subdividing the plurality of base meshes to generate the plurality of previously reconstructed meshes.

3. The encoding method according to claim 2, wherein the step of calculating the plurality of mesh displacements comprises:
calculating the plurality of mesh displacements between a surface of the mesh model and the plurality of previously reconstructed meshes.

4. The encoding method according to claim 1, wherein the three-dimension space is composed by a bitangent axis, a tangent axis and a normal axis, and the three one-dimensional arrays comprises the plurality of quantized wavelet coefficients of the mesh displacements corresponding to the bitangent axis, the tangent axis, and the normal axis.

5. The encoding method according to claim 4, wherein the step of forming the three one-dimensional arrays for the each level of detail comprises:
arranging the plurality of quantized wavelet coefficients into same group in the one-dimensional array respectively according to the bitangent axis, the tangent axis, and the normal axis.

6. The encoding method according to claim 1, wherein the step of encoding the plurality of zero-run length codes and the level values comprises:
converting the zero run length code into binary representation by using truncated Golomb Rice code, and
encoding the plurality of zero-run length codes and the level values by using an entropy encoder.

7. The encoding method according to claim 1, wherein each value of the plurality of zero-run length codes is implemented as a combination of a plurality of context-coded flags, a bypass-coded binarized reminder and a parity flag.

8. The encoding method according to claim 7, wherein the plurality of context-coded flags and the parity flag are binary.

9. The encoding method according to claim 7, wherein the step of encoding the plurality of zero-run length codes and the level values comprises:
encoding the plurality of context-coded flags by using an arithmetic encoder with a context model.

10. The encoding method according to claim 7, wherein the step of encoding plurality of the zero-run length codes and the level values comprises:
encoding the bypass-coded binarized reminder by using an exponential Golomb encoder.

11. The encoding method according to claim 1, further comprising:
quantizing the plurality of previously reconstructed meshes to generate a plurality of quantized base meshes; and
encoding the plurality of quantized base meshes to generate a coded base mesh component of the bitstream by using a static mesh encoder.

12. The encoding method according to claim 11, further comprising:
decoding the coded displacement component of a bitstream to generate another zero-run length code by using an entropy decoder;
decoding the another zero-run length code to generate another plurality of quantized wavelet transform coefficients by using a zero-run length decoder;
inversely quantizing the another plurality of quantized wavelet transform coefficients to generate another plurality of wavelet transform coefficients;
executing an inverse wavelet transform on the another plurality of wavelet transform coefficients to generate another plurality of mesh displacements;
decoding the coded base mesh component of the bitstream to generate another plurality of quantized base meshes by using a static mesh decoder;
inversely quantizing the another plurality of quantized base meshes to generate another plurality of base meshes; and
reconstructing an approximated mesh according to the another plurality of mesh displacements and the another plurality of base meshes.

13. The encoding method according to claim 11, further comprising:
executing an attribute transfer on an attribute map according to the approximated mesh to generate a transferred attribute map; and
performing attribute image padding, color space conversion and attribute video coding on the transferred attribute map to generate a coded attribute map component of the bitstream.

14. The encoding method according to claim 1, further comprising:
providing a patch information component of the bitstream.

15. A decoding method, comprising:
decoding a bitstream to generate a base mesh, and recursively subdividing to a plurality of level of details;
decoding a coded displacement component of the bitstream;
decoding the bitstream to obtain a plurality of flags and corresponding syntax elements;
reconstructing a plurality of values of a plurality of coded displacement wavelet coefficients;
processing the plurality of coded displacement wavelet coefficients by an inverse wavelet transform to generate a plurality of mesh displacements; and
generating a reconstructed mesh by applying the plurality of mesh displacements to a subdivided base mesh at each level of transform recursively.

16. The decoding method according to claim 15, wherein the step of decoding the coded displacement component of the bitstream comprising:
decoding the coded displacement component of the bitstream by using a bypass decoder.

17. The decoding method according to claim 15, wherein the step of decoding the coded displacement component of the bitstream comprising:
decoding the coded displacement component of the bitstream by using a context adaptive decoder.

18. The decoding method according to claim 15, wherein the step of decoding the bitstream to obtain the plurality of flags and corresponding syntax elements comprising:
decoding the bitstream using context coding for flags and de-binarization of the bypass coded remainder to obtain the plurality of flags and corresponding syntax elements.

19. The decoding method according to claim 15, wherein the level of details is defined by a corresponding encoder providing the bitstream.

20-33. (canceled)

34. A decoder, comprising:
a memory, configured to store a plurality of instructions, and
a processor, electrically connected to the memory, and configured to execute the plurality of instructions to implement the following decoding operations,
wherein the processor is configured to decode a bitstream to generate a base mesh, and recursively subdividing to a plurality of level of details, and is configured to decode a coded displacement component of the bitstream,
wherein the processor is configured to decode the bitstream to obtain a plurality of flags and corresponding syntax elements, and is configured to reconstruct a plurality of values of a plurality of coded displacement wavelet coefficients,
wherein the processor is configured to process the plurality of coded displacement wavelet coefficients by an inverse wavelet transform to generate a plurality of mesh displacements, and is configured to generate a reconstructed mesh by applying the plurality of mesh displacements to a subdivided base mesh at each level of transform recursively.

35-38. (canceled)
